(19) United States
(12) Patent Application Publication
(10) Pub. No.: US 2015/0286447 A1
(43) Pub. Date: Oct. 8, 2015

(54) LEFT OVER MEDIA IDENTIFICATION

(71) Applicant: OCÉ-TECHNOLOGIES B.V., Venlo (NL)

(72) Inventors: Abraham THIJSSEN, Vierlingsbeek (NL); Estella STOK, Eindhoven (NL); Jacob J.D. DE JONG, Venlo (NL)

(73) Assignee: OCÉ-TECHNOLOGIES B.V., Venlo (NL)

(21) Appl. No.: 14/743,855

(22) Filed: Jun. 18, 2015

Related U.S. Application Data
(63) Continuation of application No. PCT/EP2013/076662, filed on Dec. 16, 2013.

(30) Foreign Application Priority Data
Dec. 21, 2012 (EP) 12198818.2

(51) Int. Cl. G06F 3/12; B65H 43/00

(52) U.S. Cl. CPC G06F 3/1207; B65H 43/00; G06F 3/1258; G06F 3/126; G06F 3/1254

(57) ABSTRACT

A method for assigning an identification to at least one sheet to be removed from an input holder of an image reproduction apparatus includes the steps of detecting a trigger of removal of the at least one sheet from the input holder; and upon detection of the trigger, retrieving characteristics of the at least one sheet and printing an identification sheet comprising the retrieved characteristics for addition on top of the at least one sheet after removal of the at least one sheet from the input holder. An image reproduction apparatus is configured to execute the method.

### CROSS-REFERENCE TO RELATED APPLICATIONS

This application is a Continuation of International Application No. PCT/EP2013/076662, filed on Dec. 16, 2013, and for which priority is claimed under 35 U.S.C. §120. PCT/EP2013/076662 claims priority under 35 U.S.C. §119(a) to Application No. 12198818.2, filed in Europe on Dec. 21, 2012. The entire contents of each of the above-identified applications are hereby incorporated by reference into the present application.

### BACKGROUND OF THE PRESENT INVENTION

1. Field of the Present Invention

The present invention relates to a method for assigning an identification to at least one sheet to be removed from an input holder of an image reproduction apparatus.

2. Description of Background Art

The at least one sheet as mentioned here-above may be one sheet or a plurality of sheets forming a pile of sheets. An image reproduction apparatus, like a printer or a copier, has at least one input holder and at least one output holder. The input holder is used for putting media in it to be printed upon. Such an input holder will hereinafter also be called a holder. The output holder is used for collecting sheets after an image or a document has been printed upon the sheets. Media material is used when a print job has to be printed or a copy job has to be processed by the image reproduction apparatus. A print job or a copy job will be further referred to as a print job. When a plurality of print jobs are to be processed on the same image reproduction apparatus, it may happen that a media required for a print job which is at hand, is not present in any of the input holders of the image reproduction apparatus. In that case another media is present in an input holder and the operator has to remove the latter media from the input holder. The operator puts the media removed from the input holder on a table or at any other location where the operator usually puts leftovers of media in order to establish an empty input holder, which is ready for receiving the desired media sheets. The media that is put aside on such a location may often be almost indistinguishable from other media types on that location in terms of visual appearance. The media types have, for example a same size, a same color, but are different in grain direction, weight, etc. In this case, it is hard to recognize the media at first sight, if there are multiple media stacks on the same table or location.

U.S. Patent Application No. 2010/0032886 describes a composite feeding mechanism using a stack of input holders. The input holders can hold a receiving medium to satisfy print jobs. Receiving medium can be removed from an input holder located at the top of the stack in order to satisfy a job requirement.

### SUMMARY OF THE PRESENT INVENTION

It is an objective of the present invention to improve the identification of the at least one sheet removed from an input holder of an image reproduction apparatus.

According to the present invention, this object is achieved by a method for assigning an identification to at least one sheet to be removed from an input holder of an image reproduction apparatus, the method comprising the steps of: detecting a trigger of removal of the at least one sheet from the input holder; and upon detection of the trigger, retrieving characteristics of the at least one sheet and printing an identification sheet comprising the retrieved characteristics.

The trigger of removal of the at least one sheet may be detected by sensors in the input holder or via a signal from a user interface screen of the image reproduction apparatus. The trigger may also be detected when the user of the image reproduction apparatus uses the user interface screen to define a new media type to be placed in the input holder or in another input holder, in case the image reproduction apparatus comprises a plurality of input holders.

The characteristics of the at least one sheet are stored in memory of the image reproduction apparatus by means of a loaded digital media catalogue or when the at least one sheet has been loaded to the image reproduction apparatus. The characteristics of the at least one sheet are retrieved from memory when the trigger to unload the at least one sheet is detected.

Sheets that are removed from the input holder are kept at a specific location in order to be able to reuse the leftover media for print jobs in the future or transport the leftover media to a stock of media. The identification sheet may be printed before the removal of the at least one sheet or after the removal of the at least one sheet. When printing the identification sheet after removal of the at least one sheet from the input holder, the identification sheet may be printed on a sheet present in another input holder in case of an image reproduction apparatus comprising at least two original sheet input holders, or may be printed on a sheet from a new pile of sheets which has been put in the input holder from which the at least one sheet is just removed. The printed identification sheet comprises the characteristics of the at least one sheet which will be removed or has been removed from the input holder. The printed identification sheet may be put near or on top of, the at least one sheet after removal of the at least one sheet from the input holder.

The identification sheet eases the identification of the at least one sheet at a later moment in time after removal from the input holder.

According to an embodiment of the method of the present invention, the characteristics of the at least one sheet comprises at least one of the amount of the at least one sheet, the kind of media of the at least one sheet, the name of the operator in charge of removal, stock data, and metadata of the last job printed from the input holder. The metadata will reflect metadata of the last job printed on media from the input holder.

The amount of sheets to be unloaded may be determined in a number of known ways by the image reproduction apparatus and will not be elaborated upon. The amount of sheets may also be estimated by the image reproduction apparatus by means of the weight of the amount of sheets.

The kind of media may comprise media parameters earlier put in via a user interface at the image reproduction apparatus when the at least one sheet had been put in the input holder or when a digital media catalogue is loaded into the image reproduction apparatus. A media parameter may be an identifying media type name, a brand, a size, a color, a weight, a quality, a grain direction, etc.

Metadata of the last job printed on media from the input holder may be a job name, document name, client name, user name, printer name, date-time stamp of print job, number of prints, finishing options, double-sided or single-sided, removal time of the at least one sheet, time of receiving the trigger of removal, name of the operator, etc. The metadata may help a user to decide which leftover sheets will be used for a print job later in time.

Optionally, a barcode may be printed on the identification sheet for easy feedback of a management information system (MIS) in order to achieve an easy media stock management. The barcode may also be used when assigning or adding the right media when the leftover sheets are loaded again. The date of the first use of the media and the first store date of the media may also be established.

According to an embodiment of the present invention, the identification sheet is printed automatically upon detection of a trigger of a removal of the at least one sheet. The automatic printing of the identification sheet may be implemented as a job setting of a print job. The job setting may set automatically printing of the identification sheet after the respective print job. The automatic printing of the identification sheet may be implemented as a system setting of the image reproduction apparatus. The system setting may set automatically printing of the identification sheet after every job or when receiving the trigger like opening of a respective holder.

According to an embodiment of the present invention, the identification sheet is printed on request. The request option may be implemented as an explicit analogue or digital operable element, like a button on the image reproduction apparatus, to print the identification sheet. The operable element may be part of the user interface of the image reproduction apparatus, which user interface may be a control panel, a console, a user interface screen, a tablet or a smart phone, wireless or wired connected to the image reproduction apparatus. The operable element may be part of the input holder, a local user interface of the input holder, or a local user interface of the paper input module of the image reproduction apparatus, which module comprises the respective input holder. The latter operable element may accomplish printing of the identification sheet and consecutively opening of the respective input holder. The operable element may also be part of a finisher module of the image reproduction apparatus. In the latter case, the operable element is positioned near the location of the image reproduction apparatus where the identification sheet is delivered. The identification sheet is then collected from the output holder to be put on a location such as a media collect table near the at least one sheet which is removed from the input holder.

According to a further embodiment of the present invention, the method comprises the further steps of displaying a user input window at a user interface screen of the reproduction apparatus upon detection of the trigger of removal, requesting via the user input window an approval or a disapproval of the printing of the identification sheet, receiving the approval or the disapproval via the user input window, and printing the identification sheet only in case of a received approval.

The printing of the identification sheet on request may be implemented via interaction by means of the user interface screen of the image reproduction apparatus upon opening of the input holder. A question for the operator may be displayed at the user interface screen if an identification sheet needs to be printed.

According to an embodiment of the present invention, the method comprises the step of locking the input holder from removing the at least one sheet until the identification sheet is printed. The locking may take place after a received approval or may take place automatically when the trigger for removal, e.g. trying to open the input holder, is detected. This is advantageous since, by doing so, the user is obliged to approve the printing of the identification sheet. The identification sheet may be printed from the input holder from which the at least one sheet is to be removed or from another input holder.

According to a further embodiment of the present invention, the identification sheet is only printed on request, for example after a confirmation of the trigger for removal is received and/or an approval to print an identification sheet is received.

According to another further embodiment of the present invention, the identification sheet is mandatorily printed, for example in order to commit to a service level agreement used for the image reproduction apparatus and its users.

According to an embodiment of the present invention, the identification sheet is printed from the input holder for which a trigger of removal of the least one sheet is detected. In this case, the identification sheet is printed on media from the input holder before the actual removal of the media from the input holder has taken place. This method is in particular suitable for an image reproduction apparatus that has only one input holder for the media.

According to an embodiment, the identification sheet is printed from an input holder other than the input holder for which a trigger of removal of the least one sheet is detected. This method is in particular suitable for an image reproduction apparatus that has more than one input holder for the media. By printing from another input holder, the user has the opportunity to use media from the other input holder, which deviates from the media to be removed. The identification sheet is then printed on deviating media and jumps out in comparison with the at least one sheet.

According to an embodiment of the present invention, the identification sheet is printed to a same output holder as to which the image reproduction apparatus is currently printing a print job or to which the image reproduction apparatus has printed the last print job. This method is in particular suitable for an image reproduction apparatus that has only one output holder.

According to an embodiment of the present invention, the identification sheet is printed to an output holder other than an output holder to which the image reproduction apparatus is currently printing a print job or to which the image reproduction apparatus has printed the last print job. This method is in particular suitable for an image reproduction apparatus that has more than one output holder. In this way, the printing of the document of the print job is not noticeably delayed. The printing of the document and the identification sheet are presented as a simultaneous action. This is in particular handy when a large print job is being processed and the trigger for removal of sheets from the input holder is detected. The first output holder may be a non-standard output holder, for example an error output holder.

According to an embodiment of the present invention, the identification sheet is printed as a duplex sheet. By printing the identification data on the front side of the identification sheet as well as on the back side of the identification sheet, the identification data will always be visible whatsoever side is put upside on top of the pile of removed sheets.

According to an embodiment of the present invention, the identification data that is most important for the user is printed in a margin of the identification sheet. This is advantageous, since the most important data is still visible when more piles of media are stacked and the identification sheets are shifted a margin width out of the stack.

The invention also relates to an image reproduction apparatus for printing a digital image on a receiving medium, the image reproduction apparatus comprising: a print unit; an input holder for holding sheets of the receiving medium; a user interface unit; and a controller for controlling the print unit and the user interface unit, said controller comprising: a detector configured to detect a trigger of removal of at least one sheet from the input holder; and a retrieving device configured to retrieve characteristics of the at least one sheet upon detection of the trigger, wherein the print unit is configured to print an identification sheet comprising the retrieved characteristics.

According to an embodiment of the image reproduction apparatus according to the invention, the controller comprises a requesting device configured to request via a user input window at the user interface unit an approval or disapproval of the printing of the identification sheet upon detection of the trigger and a receiver configured to receive an approval or a disapproval via the user interface window, wherein the controller is configured to print the identification sheet only in case of a receipt of an approval by the receiver.

The invention also relates to a method for assigning an identification to at least one consumable to be removed from an image reproduction apparatus, the method comprising the steps of: detecting a trigger of removal of the at least one consumable from the image reproduction apparatus; and upon detection of the trigger, retrieving characteristics of the at least one consumable and printing an identification sheet comprising the retrieved characteristics.

According to an embodiment of the present invention, the characteristics of the at least one sheet comprises at least one of the amount of the at least one consumable, a remaining amount of content of the at least consumable, if applicable, the kind of the at least consumable, stock data, data of counters of the image reproduction apparatus, and lifetime data of the at least one consumable.

According to an embodiment of the present invention, the method comprises the further steps of displaying a user input window at a user interface screen of the reproduction apparatus upon detection of the trigger of the removal of the at least one consumable, requesting via the user input window an approval or a disapproval of the printing of the identification sheet, receiving the approval or the disapproval via the user input window, and printing the identification sheet only in case of a received approval.

According to an embodiment of the present invention, the method comprises the step of a locking opening-closing device for opening the image reproduction apparatus for removal of the at least one consumable until the identification sheet is printed. The locking may take place after a received approval. The locking may be initially applied until the identification sheet has been printed. This is advantageous to avoid situations where the consumable is removed from the image reproduction apparatus and the image reproduction apparatus is not able to print the identification sheet any more due to the removed consumable.

The invention also relates to an image reproduction apparatus for printing a digital image, the image reproduction apparatus comprising: a print unit; a user interface unit; and a controller for controlling the print unit and the user interface unit, said controller comprising a detector configured to detect a trigger of removal of at least one consumable from the image reproduction apparatus; and a receiver configured to receive characteristics of the at least one consumable upon detection of the trigger, wherein the print unit is configured to print an identification sheet comprising the retrieved characteristics. The identification sheet may be put near or on top of the at least one consumable after removal of the at least one consumable from the image reproduction apparatus.

According to an embodiment of the image reproduction apparatus mentioned directly here-above, the controller comprises a requesting device configured to request via a user input window at the user interface unit an approval or disapproval of the printing of the identification sheet upon detection of the trigger and a receiver configured to receive an approval or a disapproval via the user interface window, wherein the controller is configured to print the identification sheet only in case of a receipt of an approval by the receiver.

The invention also relates to a computer program product embodied on a non-transitory computer readable medium that, when executed on a processor, performs the method according to the present invention.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a schematic drawing of a configuration of an image reproduction apparatus according to the present invention;

FIG. 1B illustrates a controller of the image reproduction apparatus according to FIG. 1A;

FIGS. 2-3 are flow diagrams of embodiments of the method according to the present invention with respect to the removal of at least one sheet from a holder;

FIG. 4 is an example of an identification sheet according to the present invention; and

FIGS. 5-6 are flow diagrams of embodiments of the method according to the present invention with respect to the removal of at least one consumable from the image reproduction apparatus.

### DETAILED DESCRIPTION OF THE PREFERRED EMBODIMENTS

The present invention will now be described with reference to the accompanying drawings, wherein the same reference numerals have been used to identify the same or similar elements throughout the several views.

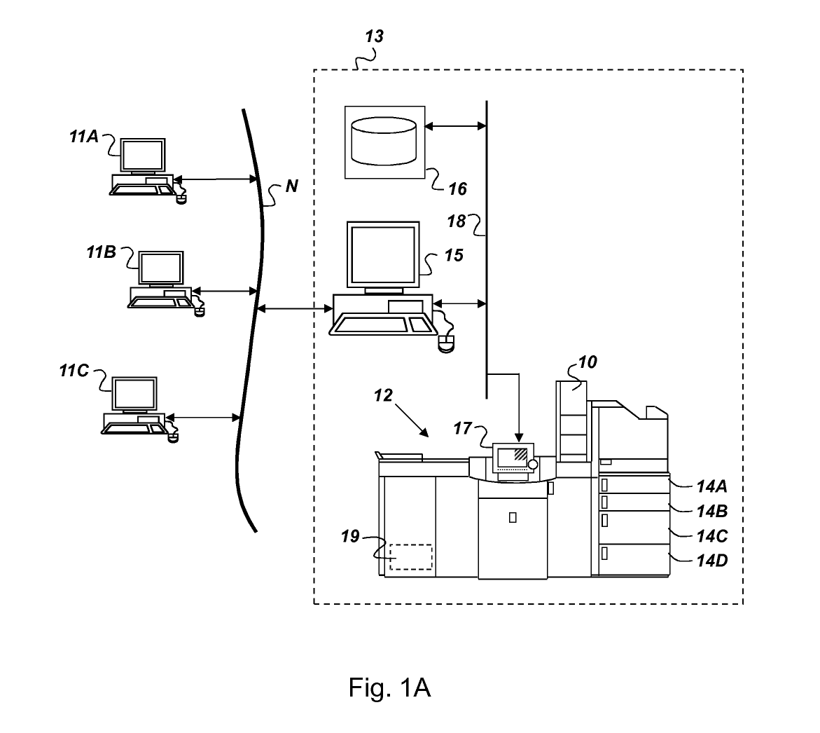

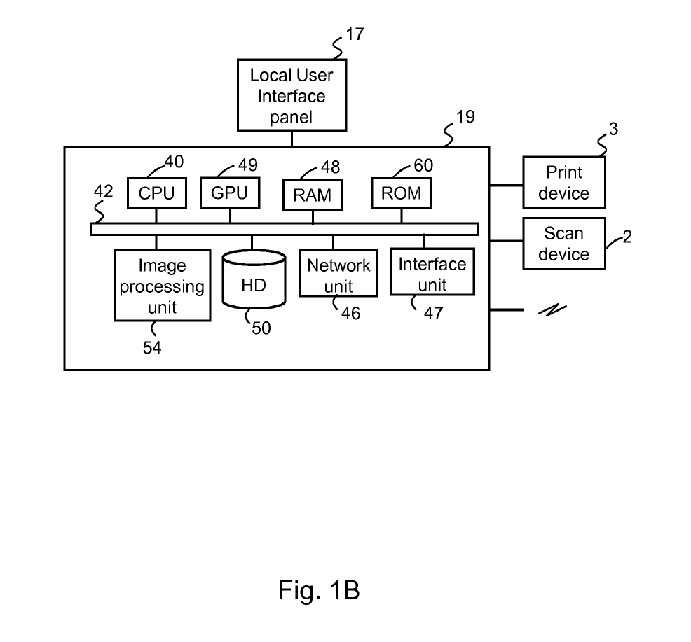

FIG. 1A illustrates a general reproduction system including user workstations 11A-11C (e.g., PCs) and a printing facility 13, all connected by a network N such as a Local Area Network, or even the Internet. The printing facility includes an image reproduction apparatus 12 and a work station 15, which may include a server operating system or a normal operating system for a PC. The printing facility may also include a document database 16 or be connected to a central database facility acting as a document database. The devices in the printing facility are interconnected by a local network 18, which may be part of the general network N.

In operation, users prepare documents on their workstations and submit the resulting document data files to the centralized printing facility for printing and possibly storage in the database 16. The files for printing are received by the server 15 and are, under the control of a user or operator, transferred to the image reproduction apparatus 12. The server 15 runs program software and so forms a system for editing and specifying the print processing of the print job that produces the prints according to the document file submitted by the users. Job history data may be stored at the server 15 or at the controller 19 of the image reproduction apparatus 12.

The image reproduction apparatus 12 has a local user interface 17 mounted on top of the image reproduction apparatus 12. The local user interface may also be integrated in a front panel of the image reproduction apparatus. The local user interface 17 may be a touch screen. The image reproduction apparatus 12 comprises a controller 19 for controlling the receiving, scheduling and processing of print jobs and the processing of copy jobs. The image reproduction apparatus 12 comprises a print device for printing a print job on a receiving material like sheets. The image reproduction apparatus 12 comprises a scan device for scanning a hardcopy original in case of a copy job. The image reproduction apparatus 12 comprises output holders 10 for delivering the print jobs. The image reproduction apparatus 12 may also comprises at least one finishing module (not shown) for post-processing the delivered print jobs, like binding, gluing, folding, etc. The image reproduction apparatus 12 also comprises at least one input holder 14A-14D for holding media on which documents are to be printed or copied. Each input holder 14A-14D comprises an opening-closing device, for example a door. The input holder 14A-14D can be opened via the opening-closing device to put in a pile of sheets or to remove a pile of sheets that is already present in the input holder. After a pile of sheets is put in, the input holder can be closed again by the opening-closing device.

When a print job arrives at the image reproduction apparatus 12 and the job is ready to be printed, settings of the print job are displayed on the local user interface 17. The elucidation hereinafter assumes the settings of the print job to be displayed at the local user interface 17 of the image reproduction apparatus 12. However, embodiments showing the settings of a print job on a work station arranged in the network N, e.g. on a window of a suitable printer driver, are not excluded from the scope of the present invention.

The image reproduction apparatus according to the present invention may be an electro-photographical printer, an inkjet printer, or any other kind of image reproduction apparatus. An embodiment of the image reproduction apparatus uses sheets of receiving material. Receiving material may be paper, textile, metal plates, printed circuit plates, solar cell plates, overhead sheet material, plastic or any other kind of suitable receiving material or substrate. The image reproduction apparatus may comprise finishing options. However, finishing options of external finishing equipment may be coupled to the production system to finish a printed or copied job and to deliver the printed or copied job according to the wishes of a sender or a user of the print or copy job, respectively.

FIG. 1B illustrates an embodiment of the controller 19 in more detail. The controller 19 comprises a Central Processing Unit (CPU) 40, a Graphical Processor Unit (GPU) 49, a Random Access Memory (RAM) 48, a Read Only Memory (ROM) 60, a network unit 46, an interface unit 47, a hard disk (HD) 50, and an image processing unit 54 such as a Raster Image Processor (RIP). The aforementioned units 40, 49, 48, 60, 46, 47, 50, 54 are interconnected through a bus system 42. However, the controller 19 may also be a distributed controller.

The CPU 40 controls the print device 2 and the scan device 3 of the image reproduction apparatus in accordance with control programs stored in the ROM 60 or on the HD 50 and the local user interface panel 17. The CPU 40 also controls the image processing unit 54 and the GPU 49.

The ROM 60 stores programs and data such as a boot program, a set-up program, various set-up data or the like, which are to be read out and executed by the CPU 40.

The hard disk 50 is an example of a non-volatile storage unit for storing and saving programs and data which make the CPU 40 execute a print process to be characterized later. Characteristics of media, for example a digital media catalogue, may be stored on the hard disk 50 or in the ROM 60. The hard disk 50 also comprises an area for saving the data of externally submitted print jobs. The programs and data on the HD 50 are read out from the RAM 48 by the CPU 40 as needed. The RAM 48 has an area for temporarily storing the programs and data read out from the ROM 60 and HD 50 by the CPU 40, and a work area which is used by the CPU 40 to execute various processes. The interface card 47 connects the controller 19 to the scan device 2 and the print device 3. The characteristics of the media in the holders 14A-14D may be stored on the hard disk 50 or in the ROM 60.

The network card 46 connects the controller 19 to the network N and is designed to provide communication with the workstations 11A-11C (See FIG. 1A), and with other devices reachable via the network.

The image processing unit 54 may be implemented as a software component running on an operation system of the controller 19 or as a firmware program, for example embodied in a field-programmable gate array (FPGA) or an application-specific integrated circuit (ASIC). The image processing unit 54 has functions for reading, interpreting and rasterizing the print job data. Said print job data contains image data to be printed (i.e. fonts and graphics that characterize the content of the document to be printed, characterized in a Page Description Language or the like), image processing attributes and print settings.

Basic modes of operation for the reproduction system are scanning, copying and printing.

The digital image obtained by the scan device 2 may be stored on a memory of the controller 19 and be handled according to a copy path, wherein the image is printed by the print device 3. Alternatively, the digital image may be transferred from the controller 19 to a client computer 11A-11C (scan-to-file path). A user of the client computer 11A-11C may decide to print a digital image, which reflects the printing mode of operation of the system.

An operable element (not shown) for printing the identification sheet on request, like a button, may be displayed on the local user interface 17 as a digital button, icon, thumb nail, etc., or as an analogue button near a screen of the local user interface 17. The operable element may be part of at least one of the holders 14A-14D. If a holder 14A-14D has a user interface screen of its own, the operable element may be part of the user interface screen of the holder 14A-14D.

The operable element may be integrated in the opening-closing device of the holders 14A-14D. Moreover, the opening-closing device may also act as the operable element and generate a trigger of removal of media from the respective holder 14A-14D to the controller 19.

The operable element may be part of the output holders 10 of the image reproduction apparatus 12 as shown in FIG. 1A.

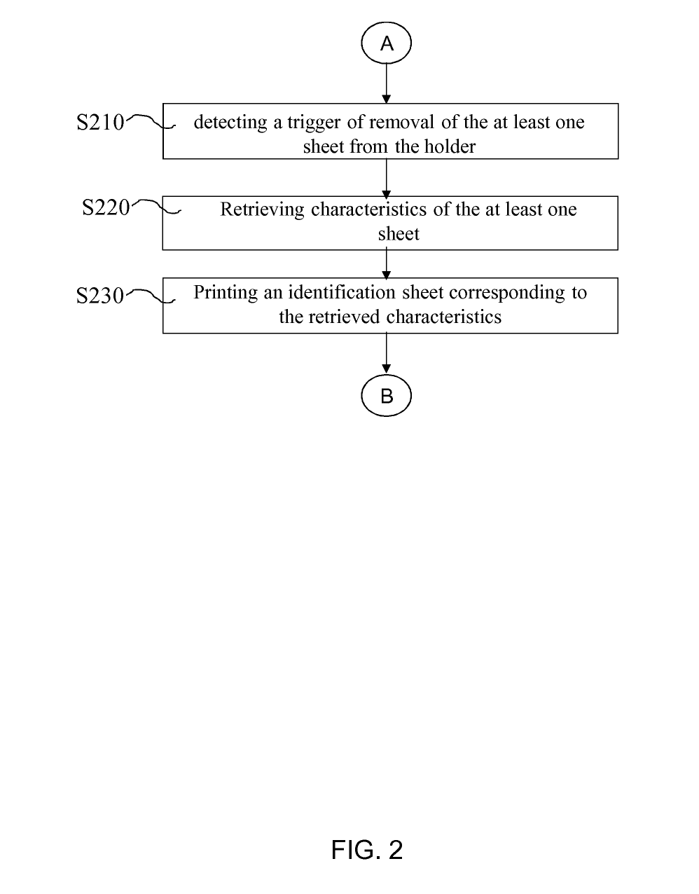

FIG. 2 is a flow diagram of an embodiment of the method according to the present invention. Starting point A leads to a first step S210 of detecting a trigger of removal of at least one sheet from the holder. Such a trigger may be initiated by opening of the opening-closing device of the holder, a request of the user to print an identification sheet, or a difference in weight sensed in the holder by appropriate weight sensors. The trigger may also be a signal from the user interface of the image reproduction apparatus.

According to a second step S220, the characteristics of the at least one sheet in the holder are retrieved. The characteristics of the at least one sheet may comprises the amount of the at least one sheet, the kind of media of the at least one sheet, stock data or metadata regarding the last job printed from the holder. The media characteristics of the media of the at least one sheet in the holder, stock data and metadata regarding the last job printed form the holder may be retrieved from a hard disk in the image reproduction apparatus or from a server connected to the image reproduction apparatus. The amount of sheets that has to be unloaded may be retrieved by means of a weight sensor in the holder or a visual sensor in the holder. The amount of sheets may also be calculated based the original amount of sheets and on usage of the sheets during print jobs. The identification sheet may comprise characteristics of media removed from more than one holder. For example, there may be more than one holder for containing the same media which have to be emptied for a next print job. The identification sheet may also contain a schematic diagram of the image reproduction apparatus in order to guide the operator as to which holders need emptying.

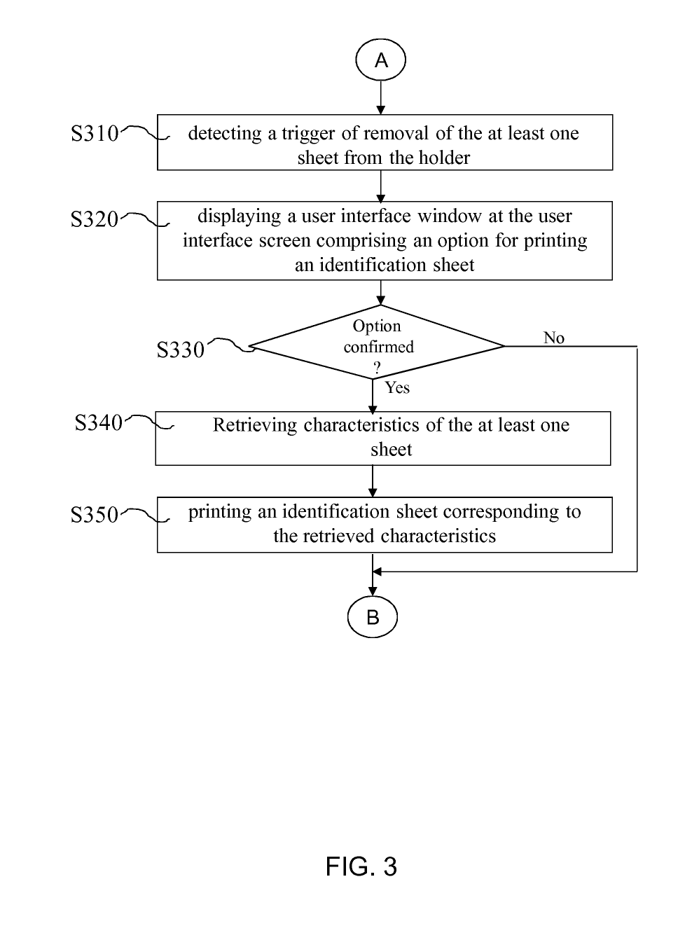

According to a third step S230, an identification sheet is printed corresponding to the retrieved characteristics. The printing of the identification sheet may be performed automatically when the trigger of removal is detected or when the removal itself is detected, for example by the opening-closing device of the holder or a weight sensor or visual sensor in the holder. The printing of the identification sheet may also be on request via the user interface of the image reproduction apparatus, which will be elucidated in FIG. 3.

The at least one sheet may be removed before or after the printing of the identification sheet. When the at least one sheet is removed before the printing of the identification sheet, the identification sheet may be printed on media from another holder, if there is more than one holder. In case of one holder, the printing of the identification sheet must wait until the only holder is loaded again. The identification sheet may be printed to another output holder than a default output holder, if there is a plurality of output holders. This is advantageous, since the identification sheet is separated from the prints of the print jobs that have been processed or from the prints that are processed at the very moment.

The method ends in end point B and the user or operator is able to collect the identification sheet from the appropriate output holder and to put the identification sheet near or on top of the at least one sheet, which has been removed from the holder and has been put on an appropriate location like a table.

FIG. 3 is a flow diagram of a further embodiment of the method according to the present invention. Starting point A leads to a first step S310 of detecting a trigger of removal of the at least one sheet from the holder as already elucidated with respect to FIG. 2.

According to a second step S320, a user interface window is displayed at the user interface panel of the image reproduction apparatus. The user interface window comprises an option for printing an identification sheet. The user can select a printing of the identification sheet or not.

In a third step S330, the user input is analyzed for the specific option. If the option is confirmed, the method proceeds with a fourth step S340, otherwise the method proceeds to and ends in end point B. In a further embodiment, the option query of the third step S330 is accompanied by a request to the user or operator to indicate the holder from which media is to be used to print the identification sheet. This is in particular advantageous, if there is a plurality of input holders. The media in some input holders may be more suitable for printing the identification sheet, for example more robust, cheaper or more distinguishable, for example white standard paper, than media in the other input holders.

In the fourth step S340, characteristics of the at least one sheet in the holder are retrieved as already elucidated with respect to FIG. 2.

In a fifth step S350, an identification sheet is printed corresponding to the retrieved characteristics as already elucidated with respect to FIG. 2. After the fifth step S350, the method ends in end point B.

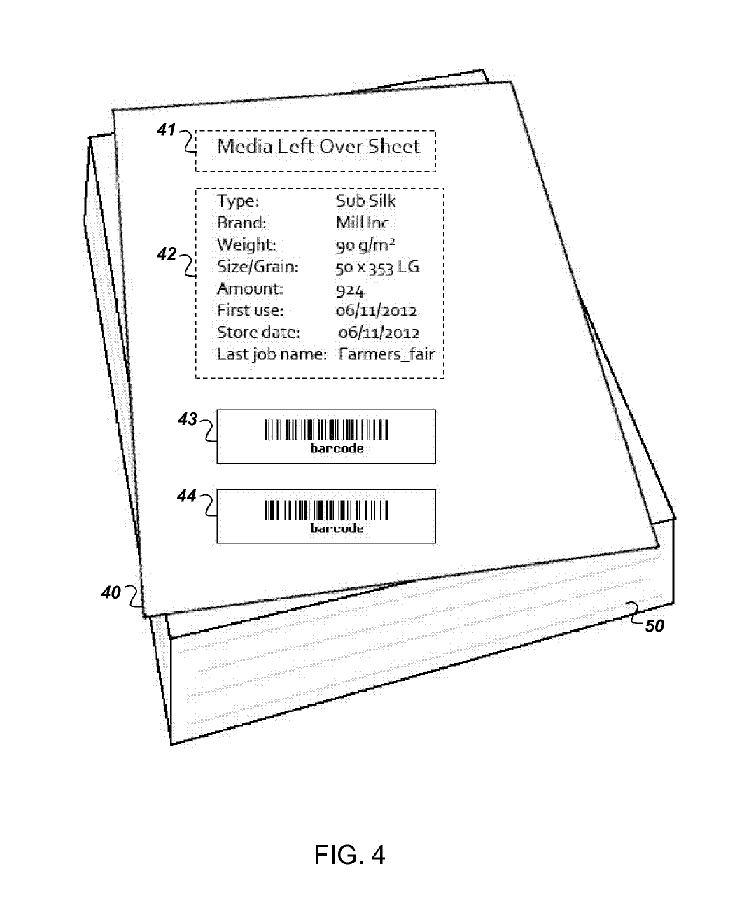

FIG. 4 illustrates an example of an identification sheet 40 printed according to the present invention. The identification sheet 40 comprises a title block named “Media Left Over Sheet,” a characteristics block 42 comprising the retrieved characteristics of the pile of sheets 50 removed from the holder, a first barcode 43 for stock management, and a second barcode 44 for assigning or adding the right media when loading it again. After the printing of the identification sheet, the user or operator of the image reproduction apparatus fetches the identification sheet from an output holder of the image reproduction apparatus and puts it on top of the removed pile of sheets 50.

If the media is of high value or is expensive, the identification sheet may be used as proof as to how many sheets or media should remain as proof to the client. The identification sheet may also be used in the aftermath how many sheets were wasted, both in actual values and in percentages, or in efficiency of the productivity. The identification sheet need not be printed on the same media as the media that is being removed, so unloading could start immediately while the machine uses a different holder to print the identification sheet.

As the identification sheet is printed for future use of the media, the media information should be printed on it, maybe together with any safety warnings, expiration date, how to stock it, or any other relevant information for a management information system, which is in particular relevant for spot color ink that remains in the image reproduction apparatus.

The method according to the present invention can also be used in order to identify a consumable that has been taken out of a machine, has been stored for a while and then is being used again because of the residual value or the residual life time. A consumable is defined as a replaceable or reusable part to be placed in or already situated in the image reproduction apparatus. A media sheet is not a consumable with respect to this definition. Such a consumable may be any supply part of the image reproduction apparatus, a replaceable part or a reusable part, as will be elucidated hereinafter. The method according to the present invention can also be used to print a label or identification sheet for attachment to an organic photoconductor, a print head, or a transfer belt for identifying a residual life time. The method according to the present invention can also be used to print a label or identification sheet for attachment to a liquid cartridge, a spot color ink cartridge or a toner cartridge for identifying an amount of liquid left, an amount of spot color ink left or an amount of toner left, respectively.

According to another embodiment of the present invention, the method comprises the step of receiving user input regarding the at least one media usage counter of the image reproduction apparatus. The usage counter may relate to a number of prints, copies and/or scans made when the appropriate consumable is present inside the image reproduction apparatus. Sometimes, the replacement of a consumable has as a consequence that a usage counter may automatically be reset. In the latter case, information regarding the lifetime of the replaced consumable may be lost. In that particular case, it is therefore appropriate to let the user enter or save this lifetime information by means of the user interface of the image reproduction apparatus before the removal of the consumable in question from the image reproduction apparatus.

When the image reproduction apparatus is returned from the customer to the manufacturer for remanufacturing by the manufacturer of the image reproduction apparatus and a technician wants an identification sheet on the current lifetime of all parts, the technician may on request print out an identification sheet as to know which parts have to be replaced or reused. Such an identification sheet may comprise characteristics of more than one part or consumable. The identification sheet may also comprise a schematic diagram of the image reproduction apparatus in order to guide the operator as to which opening-closing device of the image reproduction apparatus have to be opened in order to remove the respectively parts and/or consumables.

Typical lifetime data of a consumable are names of the jobs printed via the consumable, run time of jobs printed via the consumable, number of prints printed via the consumable, remaining life time of the consumable, the date at which the consumable has been placed into the image reproduction apparatus, etc. The identification sheet can also be used to check that key performance indicators or service level agreements have been met or for specific activity based accounting information. Obviously, this functionality can be triggered on the local user interface of the image reproduction apparatus, but also be part of an automated workflow, or embedded in a print job that this sheet is a requirement of the print job.

In an embodiment of the present invention, the image reproduction system prevents removing a consumable until the correct authorization is given. In another embodiment of the present invention, the image reproduction system prevents removing a consumable until at least two people are signed in and present for extra security.

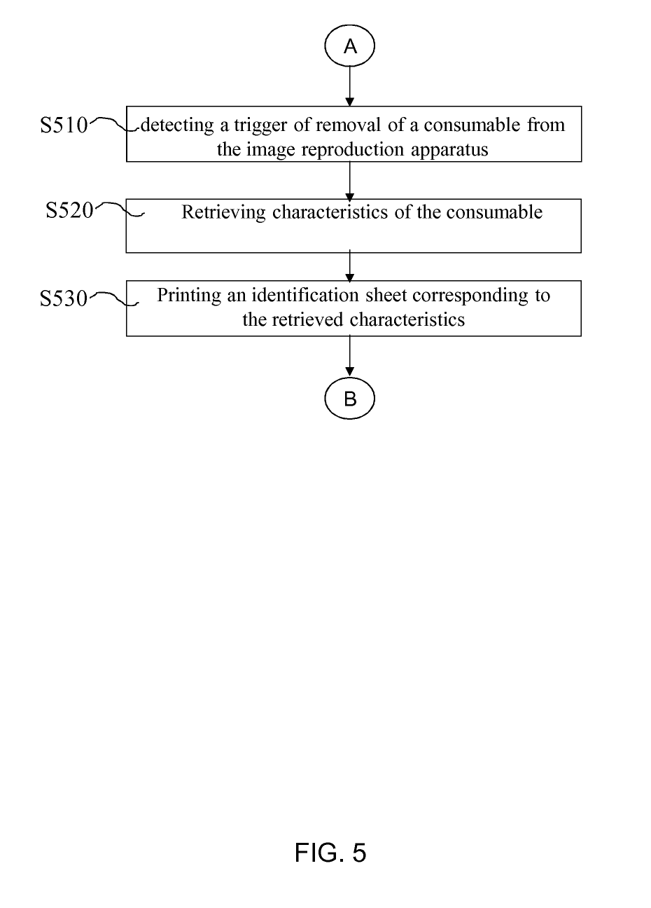

FIG. 5 is a flow diagram of an embodiment of the method according to the invention. Starting point A leads to a first step S510 of detecting a trigger of removal of a consumable from the image reproduction apparatus. Such a trigger may be an opening of an opening-closing device of the image reproduction apparatus, a request of the user to print an identification sheet for the respective consumable, a difference in weight sensed in the image reproduction apparatus by appropriate weight sensors, etc.

According to a second step S520, the characteristics of the consumable are retrieved. The characteristics of the consumable may comprise the lifetime of the consumable, at least one usage counter, or stock data. The characteristics of the consumable and the stock data may be retrieved from a hard disk in the image reproduction apparatus or from a server connected to the image reproduction apparatus. In case of a print head, the amount of the marking material, like ink and toner, left over may be retrieved by means of a weight sensor or a visual sensor in the print head or in the cartridge containing the marking material.

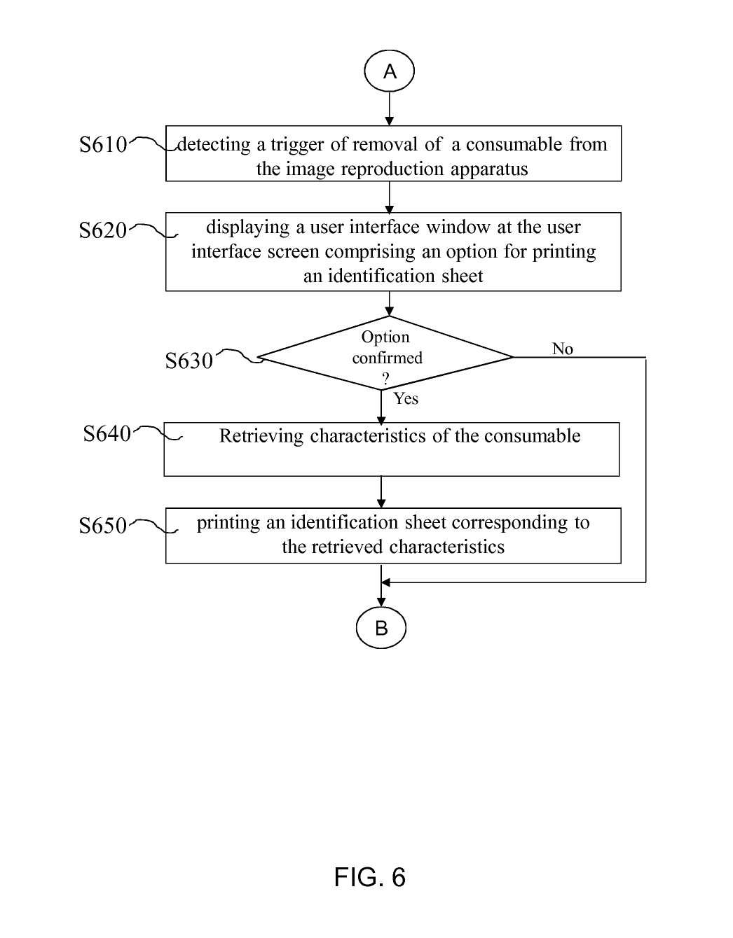

According to a third step S530, an identification sheet is printed corresponding to the retrieved characteristics. The printing of the identification sheet may be performed automatically when the trigger of removal is detected or when the removal itself is detected, for example by the opening-closing device of the image reproduction apparatus which is used to remove the consumable or a weight sensor or a visual sensor in the image reproduction apparatus at the location of the consumable in the image reproduction apparatus. The printing of the identification sheet may also be on request, which will be elucidated in FIG. 6.

The consumable may be removed before or after the printing of the identification sheet. When the consumable is removed before the printing of the identification sheet, the identification sheet may be printed on media from a holder only then when the consumable is replaced, i.e. a new consumable has been put into the image reproduction apparatus, so that the image reproduction apparatus is ready for printing again. When the consumable is removed after the printing of the identification sheet, the identification sheet may be printed on media from any input holder. The identification sheet may be printed to another output holder than a standard output holder. This is advantageous since the identification sheet is separated from the prints of the print jobs that have been processed or from the prints that are processed at the very moment.

The method ends in end point B and the user or operator is able to collect the identification sheet from the appropriate output holder and to fix the identification sheet to the removed consumable or to place it near the removed consumable. The consumable and the identification sheet together are put on an appropriate location like a table or other stock location.

FIG. 6 is a flow diagram of a further embodiment of the method according to the present invention. Starting point A leads to a first step S610 of detecting a trigger of removal of a consumable from the image reproduction apparatus as already elucidated with respect to FIG. 5.

According to a second step S620, a user interface window is displayed at the user interface panel of the image reproduction apparatus. The user interface window comprises an option for printing an identification sheet. The user can select a printing of the identification sheet or not.

In a third step S630 the user input is analyzed for the specific option. If the option is confirmed, the method proceeds with a fourth step S640, otherwise the method proceeds to and ends in end point B.

In the fourth step S640 characteristics of the consumable to be removed are retrieved as already elucidated with respect to FIG. 5.

In a fifth step S650 an identification sheet is printed corresponding to the retrieved characteristics as already elucidated with respect to FIG. 5. After the fifth step S650, the method ends in end point B.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for assigning an identification to at least one sheet to be removed from an input holder of an image reproduction apparatus, the method comprising the steps of:
detecting a trigger of removal of the at least one sheet from the input holder; and
upon detection of the trigger, retrieving characteristics of the at least one sheet and printing an identification sheet comprising the retrieved characteristics.

2. The method according to claim 1, wherein the characteristics of the at least one sheet comprises at least one of the amount of the at least one sheet, the kind of media of the at least one sheet, the name of the operator in charge of removal, stock data, and metadata of the last job printed on media from the input holder.

3. The method according to claim 1, wherein the method further comprises the steps of:
displaying a user input window at a user interface screen of the reproduction apparatus upon detection of the trigger of the removal;
requesting via the user input window an approval or a disapproval of the printing of the identification sheet;
receiving the approval or the disapproval via the user input window; and
printing the identification sheet only in case of a received approval.

4. The method according to claim 1, wherein the method further comprises the step of locking the input holder from removing the at least one sheet until the identification sheet is printed.

5. The method according to claim 1, wherein the identification sheet is printed from the input holder for which a trigger of removal of the least one sheet is detected.

6. The method according to claim 1, wherein the identification sheet is printed from an input holder other than the input holder for which a trigger of removal of the least one sheet is detected.

7. The method according to claim 1, wherein the identification sheet is printed to a same output holder as to which the image reproduction apparatus is currently printing a print job or to which the image reproduction apparatus has printed a last print job.

8. The method according to claim 1, wherein the identification sheet is printed to an output holder other than the output holder to which the image reproduction apparatus is currently printing a print job or to which the image reproduction apparatus has printed a last print job.

9. The method according to claim 1, wherein the identification sheet is printed as a duplex sheet.

10. An image reproduction apparatus for printing a digital image on a receiving medium, the image reproduction apparatus comprising:
a print unit;
an input holder for holding sheets of the receiving medium; and
a user interface unit; and a controller for controlling the print unit and the user interface unit, said controller comprising:
a detector configured to detect a trigger of removal of at least one sheet from the input holder; and
a retrieving device configured to retrieve characteristics of the at least one sheet upon detection of the trigger,
wherein the print unit is configured to print an identification sheet comprising the retrieved characteristics.

11. The image reproduction apparatus according to claim 10, wherein the controller further comprises:
a requesting device configured to request via a user input window at the user interface unit an approval or disapproval of the printing of the identification sheet upon detection of the trigger; and
a receiver configured to receive an approval or a disapproval via the user interface window,
wherein the controller is configured to print the identification sheet only in case of a receipt of an approval by the receiver.

12. A computer program product embodied on a non-transitory computer readable medium that, when executed on a processor, performs the method according to claim 1.
